(19) United States
(12) Patent Application Publication
(10) Pub. No.: US 2021/0240420 A1
(43) Pub. Date: Aug. 5, 2021

(54) CONTROL METHOD AND INFORMATION PROCESSING APPARATUS

(71) Applicant: CANON KABUSHIKI KAISHA, Tokyo (JP)

(72) Inventor: Kouichi Takahashi, Saitama (JP)

(21) Appl. No.: 17/158,937

(22) Filed: Jan. 26, 2021

(30) Foreign Application Priority Data
Jan. 31, 2020 (JP) 2020-015179

(51) Int. Cl. G06F 3/12

(52) U.S. Cl. CPC G06F 3/1258; G06F 3/126; G06F 3/1232; G06F 3/1205; G06F 3/1225

(57) ABSTRACT

A control method implemented in an information processing apparatus by at least one processor that executes print control software includes changing identification information of a print queue registered for the print control software from first identification information to second identification information, and registering, in a case where the identification information of the print queue for the print control software is changed to the second identification information, a virtual printer to which the second identification information is set as a virtual printer communicating with operating system (OS) standard print software related to the print queue.

### BACKGROUND

### Field of the Disclosure

A technique according to the present disclosure relates to a control method and an information processing apparatus.

### Description of the Related Art

There is a technique in which an operating system (hereinbelow, referred to as an OS) provides a standard print function (hereinbelow, referred to as an OS standard print function) without requiring printer-specific software (hereinbelow, referred to as a specific printer driver) provided by a printer vendor (refer to Japanese Patent No. 5806783). The OS determines whether a printer is compatible with (supports) the OS standard print function based on information obtained from the printer and transmits print data generated by the OS standard print function to the printer if the printer is compatible with the OS standard print function.

### SUMMARY

According to embodiments of the present disclosure, a control method implemented in an information processing apparatus by at least one processor that executes print control software includes changing identification information of a print queue registered for the print control software from first identification information to second identification information, and registering, in a case where the identification information of the print queue for the print control software is changed to the second identification information, a virtual printer to which the second identification information is set as a virtual printer communicating with operating system (OS) standard print software related to the print queue.

Further features of the present disclosure will become apparent from the following description of exemplary embodiments with reference to the attached drawings.

### BRIEF DESCRIPTION OF THE DRAWINGS

FIG. 1 is a block diagram illustrating an entire configuration of a print system.

FIG. 2 illustrates an example of a printer list screen, a printer registration screen, and a printer setting screen displayed by a print conversion utility.

FIG. 3 illustrates an example of a printer list screen and a printer registration screen displayed by an operating system (OS) print system.

FIG. 4 illustrates an example of a print setting screen displayed by the OS print system.

FIG. 5 is a flowchart illustrating print queue re-registration processing performed by the print conversion utility.

FIG. 6 is a flowchart illustrating print queue re-registration processing performed by the print conversion utility.

FIG. 7 illustrates an example of a screen for guiding a change in a printer name.

FIG. 8 is a flowchart illustrating print queue re-registration processing performed by the print conversion utility.

FIG. 9 is a block diagram illustrating a hardware configuration.

### DESCRIPTION OF THE EMBODIMENTS

There are some cases where a printer is not compatible with an operating system (OS) standard print function and cannot interpret print data generated by the OS standard print function. Further, even if the printer is compatible with the OS standard print function, printing based on a more detailed print setting than the OS standard print function is required in some cases.

Therefore, an aspect of the present disclosure is directed to the provision of a technique for enabling an appropriate print instruction using an OS standard print function.

Various exemplary embodiments of the present disclosure will be described in detail below with reference to the attached drawings. The exemplary embodiments which will be described below do not restrict the present disclosure. All of combinations of the features described in the exemplary embodiments are not always essential to the means for solution according to the present disclosure.

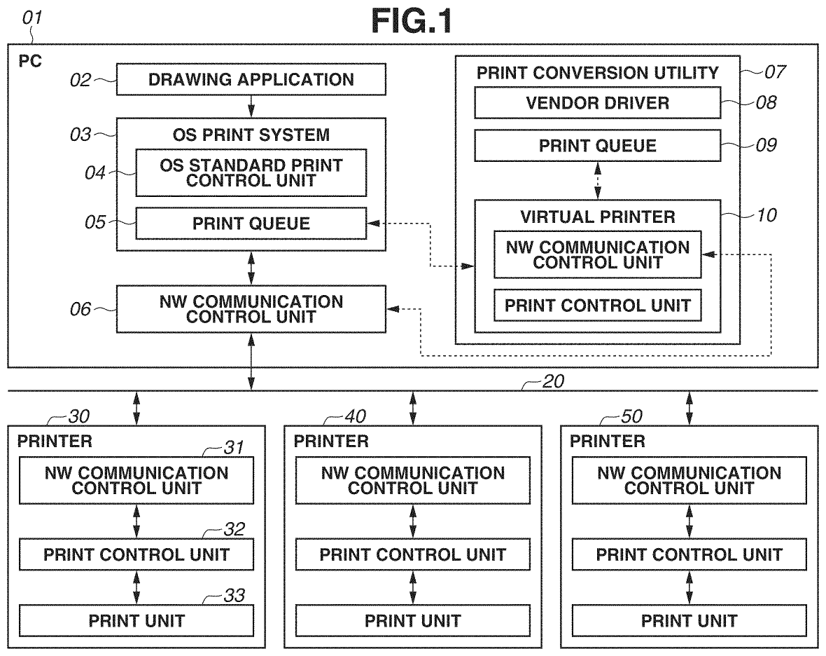

FIG. 1 illustrates an entire configuration of a print system according to a first exemplary embodiment. A personal computer (PC) 01 is connected to each of printers 30, 40, and 50 via a network 20 and can communicate with each other. According to the present exemplary embodiment, the network 20 is assumed as a local area network (LAN) but may be a wide area network (WAN). Further, a connection form of the network 20 may be wired, wireless, and mixture of them. The PC 01 controls the printers 30, 40, and 50 connected via the network 20.

### <Hardware Configuration>

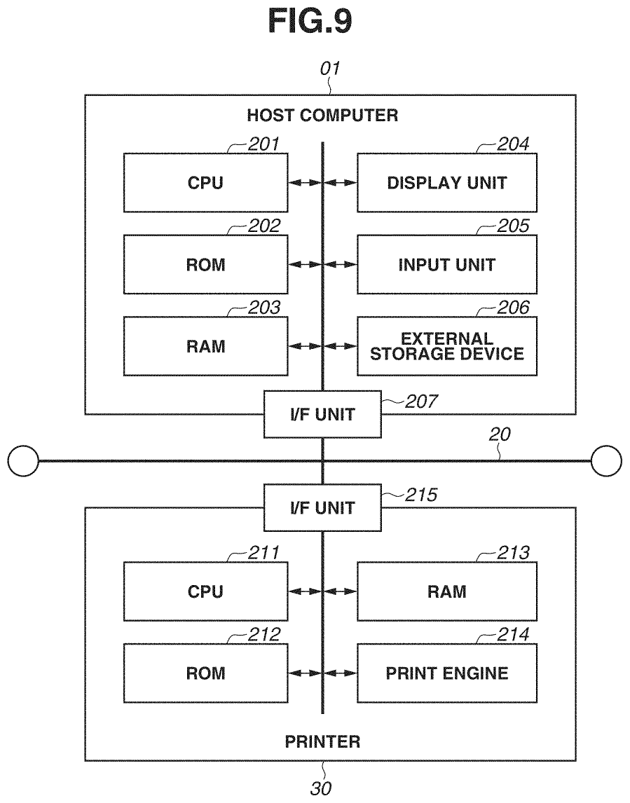

A hardware configuration of the print system according to the present exemplary embodiment is described with reference to a block diagram in FIG. 9. FIG. 9 illustrates an example of the print system in which a host computer namely the PC 01 can communicate with the printer 30. FIG. 9 illustrates the hardware configuration of the printer 30, but the printers 40 and 50 include the similar hardware configuration.

The PC 01 is an example of an information processing apparatus. The PC 01 includes, an interface (I/F) unit 207, a central processing unit (CPU) 201, a read-only memory (ROM) 202, a random access memory (RAM) 203, a display unit 204, an input unit 205, and an external storage device 206. The PC 01 according to the present exemplary embodiment is not limited to a desktop PC and may be a notebook PC, a tablet PC, and a smartphone.

The PC 01 transmits to the printer 30 an instruction to control the printer 30, print data, a setting command, and the like. The CPU 201 which controls each unit in the PC 01 executes the OS and a control program such as a print conversion utility 07 described below. The ROM 202 controls an operation of the system based on the OS stored therein. A work area of the CPU 201 is loaded in the RAM 203. The external storage device 206 stores various control programs such as an application and the print conversion utility 07 therein.

The input unit 205 is input devices such as a keyboard and a mouse for operating the PC 01. The display unit 204 is a display device which displays information input from the input unit 205 for confirmation, a user interface screen of the OS and an application, a message, and the like. The I/F unit 207 is a communication module for transmitting and receiving data to and from the printer 30.

The printer 30 as a printing apparatus is, for example, an ink jet printer. The printer 30 includes an I/F unit 215, a CPU 211, a ROM 212, a RAM 213, and a print engine 214. The CPU 211 controls each unit described below. The ROM 212 stores a program for controlling the print engine 214 therein. The RAM 213 is a memory for writing and reading as needed and temporarily stores a program necessary for an operation of the print engine 214, a set value received from the PC 01, and the like.

The print engine 214 performs printing on a recording medium based on print data transmitted from the PC 01. The I/F unit 215 is a communication module for receiving the print data from the PC 01 and has a function of transmitting current status information of the printer 30 from the printer 30 to the PC 01. The status information described here is status data indicating a status of the printer 30 which can be returned from the printer 30 in response to a request from the PC 01 connected via the I/F unit 215. The status data is information for notifying a user of an operation status of the printer 30 such as “being printed” or “standby state” and an error status of the printer 30 such as “out of paper”, “cover is open”, or “out of ink”.

### <Software Configuration of PC 01>

Returning to FIG. 1, a software configuration of the PC 01 is described. The PC 01, namely the information processing apparatus includes a drawing application 02, an OS print system 03, a network (NW) communication control unit 06, and the print conversion utility 07 which are operable. It is not illustrated in FIG. 1, but the PC 01 includes the OS, and the OS controls a resource namely each block in the PC 01. According to the present exemplary embodiment, the OS included in the PC 01 is assumed as a macOS®.

The drawing application 02 is software for generating drawing data based on a user instruction. The application described here is software which can operate on the OS. The drawing application 02 is, for example, word processing software for generating a document, image editing software, and New Year's card creation software. Drawing data to be generated by the drawing application 02 is, for example, data in a Portable Document Format (PDF) format.

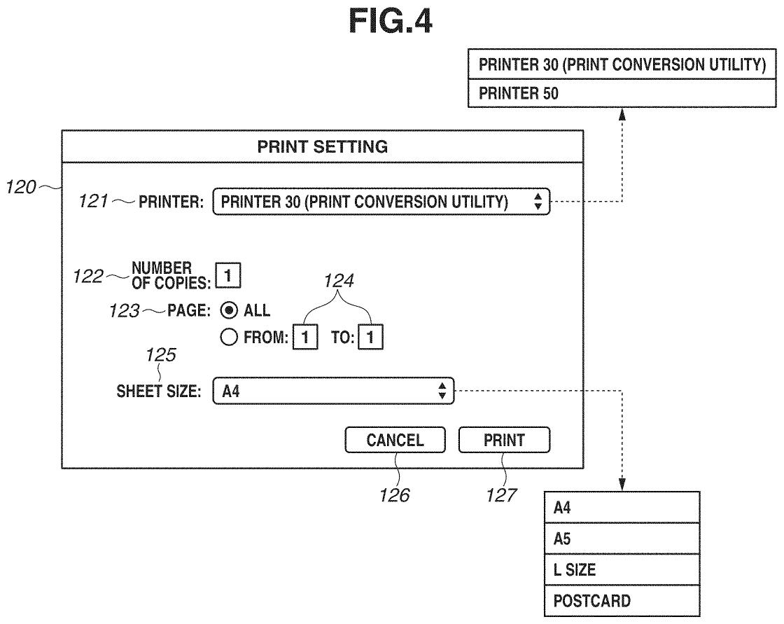

In a case where a print request is issued, the drawing application 02 outputs the generated drawing data to the OS print system 03. In a case where the print request is issued, the OS print system 03 generates a print job based on the obtained drawing data and information about a print setting. The generated print job is input to a print queue 05 for the OS standard print function. The print setting can be input by a user in advance using a setting screen (described below with reference to FIG. 4) provided by the OS print system 03. The information about the print setting includes a sheet size, a sheet type, and which print queue is used in printing. The OS print system 03 sequentially processes the print request from the drawing application 02 for each printer connected to the PC 01 as a job.

The OS print system 03 is OS standard print software which has a standard function necessary for generating print data (the OS standard print function). The OS print system 03 performs spool processing with respect to the drawing data generated by the drawing application 02 and generates print data in a predetermined format conforming to the OS standard print function (hereinbelow, also referred to as “a standard format”). The printer compatible with (supporting) the OS standard print function can interpret the print data in the standard format. Therefore, the OS print system 03 transmits the generated print data via the NW communication control unit 06 to the printer compatible with the OS standard print function.

Further, the OS print system 03 obtains model information of the printer via the NW communication control unit 06 in order to determine whether the printer supports the OS print system 03. The information to be obtained for determining the support is not limited to the model information of the printer and may be capability information of the printer and the like. Various types of processing in the OS print system 03 is performed based on control by an OS standard print control unit 04 in the OS print system 03.

The print conversion utility 07 is print control software which makes it possible to instruct the printer which is not compatible with (support) the OS standard print function to perform printing using the OS standard print function and is installed on the PC 01 as needed. The print conversion utility 07 has a function of converting print data in the standard format into print data in a format specific to a printer vendor. In the following description, this function is referred to as a vendor driver 08. The vendor driver 08 does not necessarily have to have a function equivalent to that of a conventional specific printer driver and may have at least a function of converting print data into the one in the format specific to the printer vendor. With respect to the printer which is not compatible with the OS standard print function, the print conversion utility 07 converts print the data into the print data in the format specific to the printer vendor and then transmits the converted print data via the NW communication control unit 06.

In a case of the printer which does not support the OS standard print function, if the print data in the standard format generated by the OS print system 03 is received, the printer cannot interpret the print data. Therefore, according to the present exemplary embodiment, the print conversion utility 07 converts the print data in the standard format into the print data in the format specific to the printer vendor that the printer can interpret. Accordingly, the PC 01 can cause the printer which is not compatible with the OS standard print function to perform printing using the standard function of the OS print system 03.

Specifically, in a case of a print job of the printer which does not support the OS standard print function, the OS print system 03 transmits the generated print data in the standard format to a virtual printer 10 which is started up by the print conversion utility 07. The virtual printer 10 can act as a printer compatible with the OS standard print function via the NW communication control unit and receive a print job of the OS standard print function. In other words, the OS print system 03 regards the virtual printer 10 as the printer supporting the OS standard print function and outputs the print job to the virtual printer 10. The print conversion utility 07 converts the print data in the standard format received by the virtual printer 10 into the print data in the format specific to the printer vendor and transmits the converted print data to the printer via the NW communication control unit 06. According to the present exemplary embodiment, the virtual printer 10 exists in the same PC in which the OS print system 03 exists, but may exist in another server or another PC.

Even in a case where the printer supports the OS print system 03 (in other words, in a case where the printer can interpret the print data in the standard format), the print conversion utility 07 may be used if a print instruction is the one issued to the printer supported by the print conversion utility 07. More functions can be provided with use of the print conversion utility 07. For example, in a case of the OS standard function provided by the OS print system 03, the OS standard function is not compatible with detailed print quality settings of color matching processing, adjustment of color and brightness, and the like. In other words, there is a restriction on the OS standard print function. Therefore, the print conversion utility 07 is used, and accordingly, a function equivalent to that of the printer driver specific to the printer vendor can be provided.

In order to use the print conversion utility 07 from the drawing application 02, both of the print queue 05 for the OS print system 03 and a print queue 09 for the print conversion utility 07 are necessary to be registered. The print queue 05 for the OS print system 03 is a queue for receiving a print request from the drawing application 02 and is registered in the OS print system 03. The print queue 09 for the print conversion utility 07 is a queue for controlling print data output from the virtual printer 10 and is registered in the print conversion utility 07. If both of the print queues 05 and 09 are not registered, the print data cannot be converted using the print conversion utility 07 from the drawing application 02. The print queue 09 for the print conversion utility 07 is registered, and accordingly, the print conversion utility 07 starts up the virtual printer 10. Then, the print conversion utility 07 designates the virtual printer 10 to automatically register the print queue 05 for the OS print system 03.

The print queue 09 of the print conversion utility 07 is stored in a storage area for each user. In other words, the print queue 09 of the print conversion utility 07 for a user A and the print queue 09 of the print conversion utility 07 for a user B are registered in respective different storage areas. On the other hand, the print queue 05 of the OS print system 03 is stored in a common area in the print system. In other words, the print queue 05 of the OS print system 03 is commonly used by the user A and the user B. In the following description, the print queue of the OS print system 03 is also referred to as a print queue of the OS standard print function.

### <Software Configuration of Printer>

Each of the printers 30, 40, and 50 includes a NW communication control unit 31, a print control unit 32, and a print unit 33. The print control unit 32 receives print data from the PC 01 via the NW communication control unit 31 and controls the print unit 33 to execute printing based on the print data. According to the present exemplary embodiment, the printers 30 and 40 is not compatible with the OS standard print function, and the printer 50 is compatible with the OS standard print function. The printers may be an ink jet system printing apparatus or an electrophotographic system printing apparatus.

### <Registration of Print Queue in Print Conversion Utility>

Next, in order to describe a flow of registration of the print queue 09 of the print conversion utility 07, a shift of screens to be displayed on the PC 01 is described.

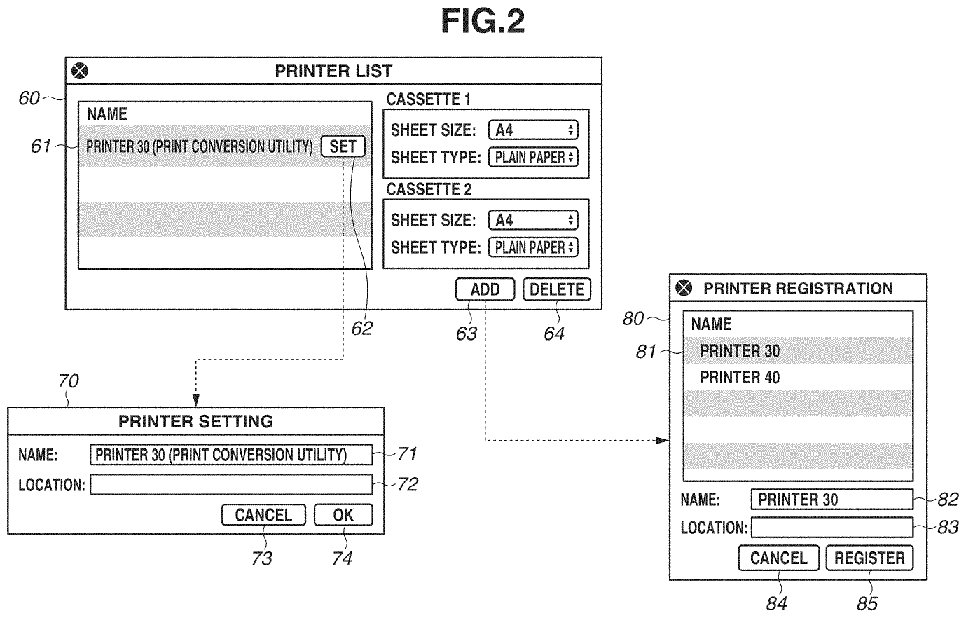

FIG. 2 illustrates a printer list screen 60 provided by the print conversion utility 07. The printer list screen 60 includes a printer name 61 of the printer registered in the print conversion utility 07, a “set” button 62 for setting the printer, an “add” button 63 for registering the printer, and a “delete” button 64 for deleting the printer. In FIG. 2, a “printer 30 (print conversion utility)” is described in the printer name 61, which indicates a state in which the print queue of the printer 30 is already registered in the print conversion utility 07. A text “(print conversion utility)” added after the “printer 30” indicates that the printer 30 is compatible with the OS standard print function via the print conversion utility 07.

If the “set” button 62 on the printer list screen 60 is pressed, the print conversion utility 07 opens a printer setting screen 70. The printer setting screen 70 includes a printer name editing field 71, a printer installation location editing field 72, a “cancel” button 73, and an “OK” button 74. The print conversion utility 07 displays name information of the print queue 09 currently registered in the print conversion utility 07 and installation location information of the printer respectively in the printer name editing field 71 and in the printer installation location editing field 72. A user can edit contents displayed in the printer name editing field 71 and the printer installation location editing field 72 on the printer setting screen 70. If the user presses the “OK” button 74, the print conversion utility 07 updates setting information of the print queue 09 of the print conversion utility 07 with the contents in the printer name editing field 71 and the printer installation location editing field 72. If the user presses the “cancel” button 73, the printer setting screen 70 is closed.

If the “add” button 63 is pressed on the printer list screen 60, the print conversion utility 07 opens a printer registration screen 80. The printer registration screen 80 includes a printer list 81. The printer list 81 displays all printers which are connected to the PC 01 and are not compatible with the OS standard function. In the printer list 81, the printers 30 and 40 are displayed which is not compatible with the OS standard print function. If the printer is selected in the printer list 81, a name and an installation location of the selected printer respectively are displayed in a printer name text field 82 and in a printer installation location text field 83. If the user presses a “register” button 85, the print queue 09 of the printer currently selected in the printer list 81 is newly registered in the print conversion utility 07 with the contents input in the printer name text field 82 and the printer installation location text field 83.

If the print queue of the printer is registered in the print conversion utility 07, the print conversion utility 07 starts up the virtual printer 10 based on the information about the registered printer by adding internally generated support information with respect to the OS standard print function. Specifically, the print conversion utility 07 starts up the virtual printer 10 based on the information about the printer (a model name, the printer name, and the installation location information of the printer) and the support information (a Universally Unique Identifier (UUID) and capability information). Accordingly, the print conversion utility 07 newly registers the virtual printer 10 which is associated with the registered print queue 09 and is set with a name that is the same as a name of the registered print queue 09 (identification information). Accordingly, the virtual printer 10 responds to the OS print system 03. In the registration, a text “print conversion utility” is added to the name of the print queue 09 of the print conversion utility 07 and the name of the virtual printer 10. If the print queue 09 is registered in the print conversion utility 07, and the virtual printer 10 related to the print queue 09 is started up, the print conversion utility 07 executes a registration command of the print queue 05 of the OS standard print function based on information responding to the OS print system 03. According to the above-described processing, the print queue 05 is automatically registered in the OS print system 03 without a user operation on a screen of the OS print system 03.

If the “delete” button 64 is pressed on the printer list screen 60, the print conversion utility 07 deletes the print queue 09 of the selected printer in the print conversion utility 07. Further, the print conversion utility 07 stops the virtual printer 10 associated with the print queue 09 as a deletion target. In other words, the print conversion utility 07 deletes the virtual printer 10 related to the print queue 09 as the deletion target. Further, the print conversion utility 07 deletes the print queue 05 of the OS standard print function by executing a deletion command with respect to the print queue 05 of the OS standard print function. The registration and deletion of the print queue 05 of the OS standard print function can be manually performed from the OS print system 03 described below.

### <Registration of Print Queue in OS Print System>

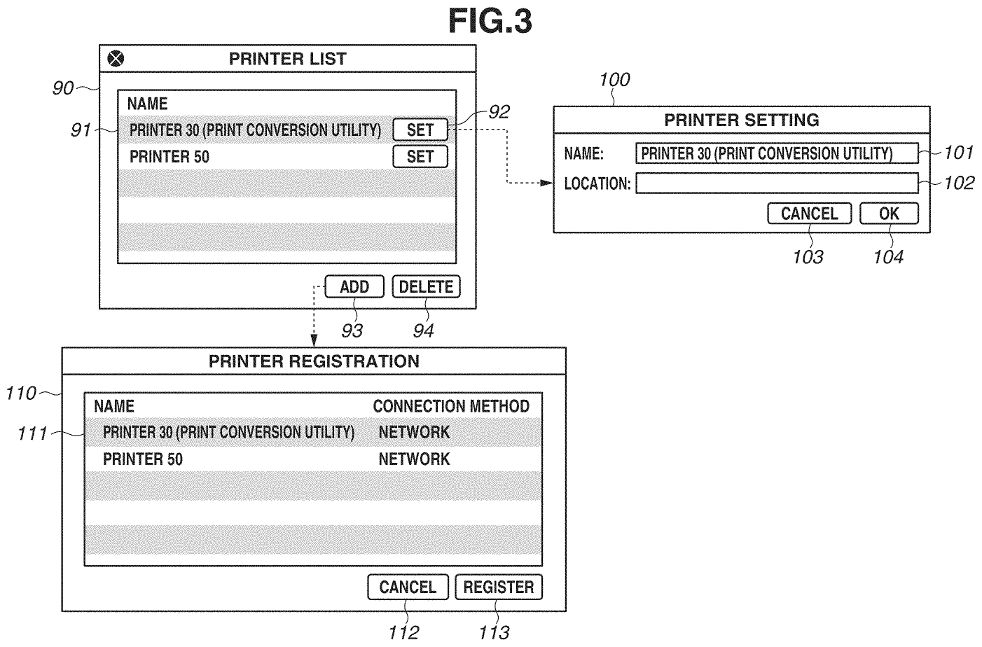

Next, in order to describe a flow of registration of the print queue 05 in the OS print system 03, a shift of screens to be displayed on the PC 01 is described. FIG. 3 illustrates a printer list screen 90 provided by the OS print system 03. The printer list screen 90 includes a printable printer list 91 which displays all printers which can be selected in printing. If a user selects the printer in the printable printer list 91 and presses a “set” button 92, the OS print system 03 displays a printer setting screen 100.

The printer setting screen 100 includes a printer name editing field 101, a printer installation location editing field 102, a “cancel” button 103, and an “OK” button 104. The print conversion utility 07 displays name information of the print queue 05 of the printer currently registered in the OS standard print function and the installation location information of the printer respectively in the printer name editing field 101 and in the printer installation location editing field 102. The user can edit contents displayed in the printer name editing field 101 and the printer installation location editing field 102 on the printer setting screen 100. If the user presses the “OK” button 104, the OS print system 03 updates setting information of the print queue 05 of the OS standard print function with the contents in the printer name editing field 101 and the printer installation location editing field 102. If the user presses the “cancel” button 103, the OS print system 03 closes the printer setting screen 100. If the user presses a “delete” button 94, the OS print system 03 deletes the print queue of the selected printer and also deletes the selected printer from the printable printer list 91.

If the user presses an “add” button 93 on the printer list screen 90, the OS print system 03 displays a printer registration screen 110. The printer registration screen 110 includes a registration printer list 111 which displays all printers which are connected to the PC 01 and compatible with the OS standard print function. In this case, the OS print system 03 obtains a printer's name and capability information including the support information with respect to the OS standard print function from the printer 50 which is connected to the PC 01 and compatible with the OS standard print function and displays the obtained information in the registration printer list 111. Further, the OS print system 03 obtains the name and capability information from the virtual printer 10 started up by the print conversion utility 07. In this case, the printer 30 is an operation target of the print conversion utility 07, and the virtual printer 10 corresponding to the printer 30 is started up (registered). Therefore, the OS print system 03 obtains the capability information from the virtual printer 10 of the printer 30 started up by the print conversion utility 07 and displays the registration printer list 111 based on the obtained capability information. A virtual printer name “printer 30 (print conversion utility)” as a name of the printer 30 and “Network” as a connection method are displayed in the registration printer list 111.

If the user selects the printer from the registration printer list 111 and presses a “register” button 113 on the printer registration screen 110, the OS print system 03 generates the print queue 05 of the selected printer in the OS print system 03 and closes the printer registration screen 110. If the user presses a “cancel” button 112, the OS print system 03 closes the printer registration screen 110 without registering the print queue of the printer.

The printer list screen 90 in FIG. 3 indicates a state in which the print queue of the printer 30 and the print queue of the printer 50 are registered in the OS print system 03. The printer 30 does not support the OS standard print function, but the virtual printer 10 corresponding to the printer 30 exists since the print queue of the printer 30 is registered in the print conversion utility 07. Therefore, the OS print system 03 obtains the printer's name and the capability information from the virtual printer 10 corresponding to the printer 30 and registers a print queue of the virtual printer 10 in the OS print system 03. As described with reference to FIG. 2, the name of the virtual printer 10 is the same as that of the print queue registered in the print conversion utility 07. Therefore, the print queue of the virtual printer 10 corresponding to the printer 30 is registered in the OS print system 03, and accordingly, it can be considered that the print queue of the printer 30 is registered.

### <Print Setting Screen>

FIG. 4 illustrates a print setting screen 120 of the OS print system 03. The print setting screen 120 is a screen for a user to instruct the print setting for printing data generated with the drawing application 02.

The user can designate the printer for performing printing in a printer selection popup menu 121. The OS print system 03 displays the printer registered in the printer list screen 90 in FIG. 3 as a selectable printer. According to the present exemplary embodiment, the printer 30 which is regarded as being compatible with the OS standard print function in a pseudo manner via the print conversion utility 07 and the printer 50 compatible with the OS standard print function are registered as the printable printers. Therefore, the printers 30 and 50 are displayed in the printer selection popup menu 121. The user can set the number of copies to be printed in a copy number setting text field 122. The user can set a page to be printed using a page setting radio button 123 and a page designation text field 124. The user can set a sheet size to be used in printing in a sheet size setting popup menu 125. The user can set any of sheet sizes of A4, A5, L size, and postcard which are printable by the printer. If the user presses a “print” button 127, the OS print system 03 inputs a print job based on the settings in the present screen and also closes the present screen. If the user presses a “cancel” button 126, the OS print system 03 closes the present screen without inputting the print job.

As described above, in a case of the printer which does not support the OS standard print function, a default value of the name of the print queue to be registered in the OS print system 03 is the name of the virtual printer 10 associated with the printer. Further, the virtual printer 10 is associated with the print queue of the print conversion utility 07. In other words, a default name of the virtual printer 10 is the name of the print queue of the print conversion utility 07.

The print queue name of the print conversion utility 07 and the print queue name of the OS print system 03 can be changed by a user. However, in a case where the print queue name of the print conversion utility 07 is changed, the name of the virtual printer 10 associated with the print queue and the print queue name in the OS print system 03 cannot be changed from the print conversion utility 07. Therefore, the print queue name of the print conversion utility 07 can be different from the name of the virtual printer 10 and the print queue name in the OS print system 03 in some cases. In such a case, although these names correspond to the same printer but the names do not match with one another, it may be difficult for a user to determine the printer as a print target.

Therefore, an example is described below in which the name of the virtual printer 10 and the print queue 05 of the OS standard print function are re-registered in a case where a user changes the name of the print queue 09 of the print conversion utility 07.

### <Processing Flow in Change in Print Queue Name of Print Conversion Utility 07>

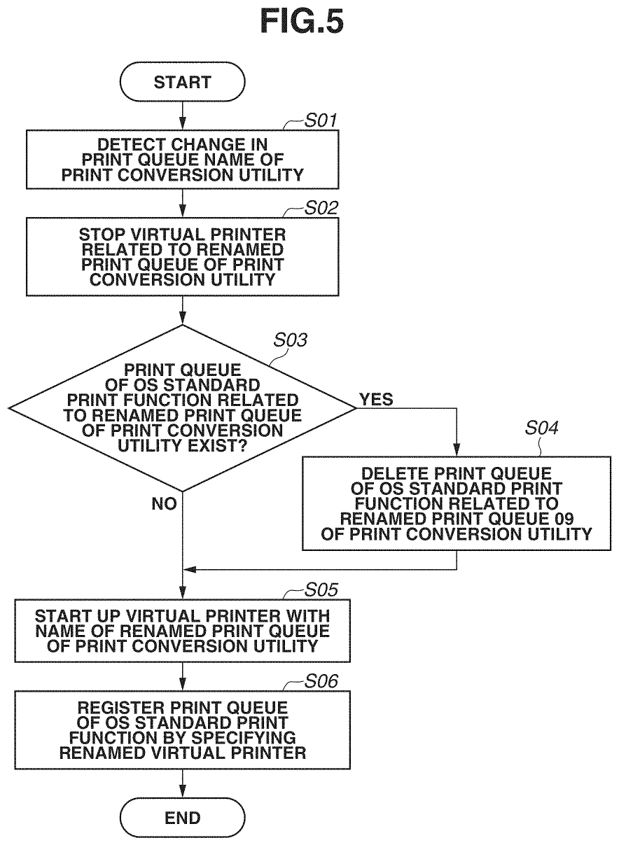

FIG. 5 is a flowchart illustrating a processing flow executed by the print conversion utility 07. The processing flow in FIG. 5 is started if a user starts up the print conversion utility 07. FIG. 5 illustrates a case in which the user starts up the print conversion utility 07 and changes the name of the print queue 09 registered in the print conversion utility 07. The print conversion utility 07 is described below as an entity of each process, but in reality, the CPU 201 executes a corresponding program and thus realizes a corresponding function. All pieces of processing are not necessarily executed sequentially on one process, and there may be a case in which the processing is transferred to the OS side once and is called again from the OS. The processing flow in FIG. 5 illustrates main processing by the print conversion utility 07 in an easy-to-understand manner for convenience.

In step S01, the print conversion utility 07 detects that the name (identification information) of the print queue 09 registered in the print conversion utility 07 is changed and sets the changed name. Here, it is assumed that the name of the print queue 09 of the printer 30 registered in the print conversion utility 07 is changed from “printer 30 (print conversion utility)” to “favorite printer 30 (print conversion utility)”.

In step S02, the print conversion utility 07 stops the virtual printer 10 related to the renamed print queue 09 of the print conversion utility 07. In other words, the virtual printer 10 of which name is set as “printer 30 (print conversion utility)” is deleted.

In step S03, the print conversion utility 07 determines whether the print queue 05 of the OS standard print function related to the renamed print queue 09 of the print conversion utility 07 exists. In other words, the print conversion utility 07 determines whether the print queue of which the name is set as “printer 30 (print conversion utility)” is registered in the OS print system 03. If the print conversion utility 07 determines that the print queue 05 of the OS standard print function related to the renamed print queue 09 of the print conversion utility 07 exists (YES in step S03), the processing proceeds to step S04, whereas if not (NO in step S03), the processing proceeds to step S05.

In step S04, the print conversion utility 07 executes processing for deleting the print queue 05 of the OS standard print function related to the renamed print queue 09 of the print conversion utility 07. In other words, the print conversion utility 07 deletes the print queue 05 of which the name is set as “printer 30 (print conversion utility)” from the OS print system 03.

In step S05, the print conversion utility 07 starts up the virtual printer 10 with a name of the renamed print queue 09 of the print conversion utility 07. In other words, the print conversion utility 07 newly registers the virtual printer 10 of which the name is set as “favorite printer 30 (print conversion utility)”.

In step S06, the print conversion utility 07 executes processing for newly registering the print queue 05 of the OS standard print function by specifying the renamed virtual printer 10 which is started up in step S05. In other words, the print conversion utility 07 newly registers the print queue 05 having the name “favorite printer 30 (print conversion utility)” in the OS print system 03 as the print queue 05 related to the virtual printer 10 having the name “favorite printer 30 (print conversion utility)”.

According to the present exemplary embodiment, in a case where the name of the print queue 09 of the print conversion utility 07 is changed, stop and start-up of the related virtual printer 10 and deletion and registration of the related print queue 05 of the OS standard print function are performed by the above-described processing. Accordingly, the names of the print queue 09 of the print conversion utility 07, the virtual printer 10, and the print queue 05 of the OS standard print function match with one another. Therefore, the present exemplary embodiment has an effect of enabling a user to easily determine the printer for performing printing and to issue an appropriate print instruction.

Next, a second exemplary embodiment according to the present disclosure is described. In the following description, a part common to the first and second exemplary embodiments is omitted, and only a different point is described. According to the present exemplary embodiment, in a case where the name of the print queue 09 of the print conversion utility 07 is changed, and then the virtual printer 10 is started up with the changed name, it is determined whether a device (here, a printer) having a name that is the same as the changed name exists in the network to which the PC 01 is connected.

In order for the OS print system to identify a printer which can use the OS standard print function, it is necessary for the printer to have a unique name on the network to which the PC is connected. Therefore, in a case where a device (here, a printer) having the same name as the renamed virtual printer 10 already exists in the network, a number is added to an end of the name of the virtual printer 10 according to a discovery protocol. In this case, the name of the virtual printer 10 does not become the one intended by a user, and thus it is difficult for the user to determine the printer. In consideration of this point, according to the second exemplary embodiment, in a case where the name of the virtual printer 10 which is started up after the name change exists in the network, a user is notified of the fact and prompted to change the name of the print queue 09 of the print conversion utility 07 again.

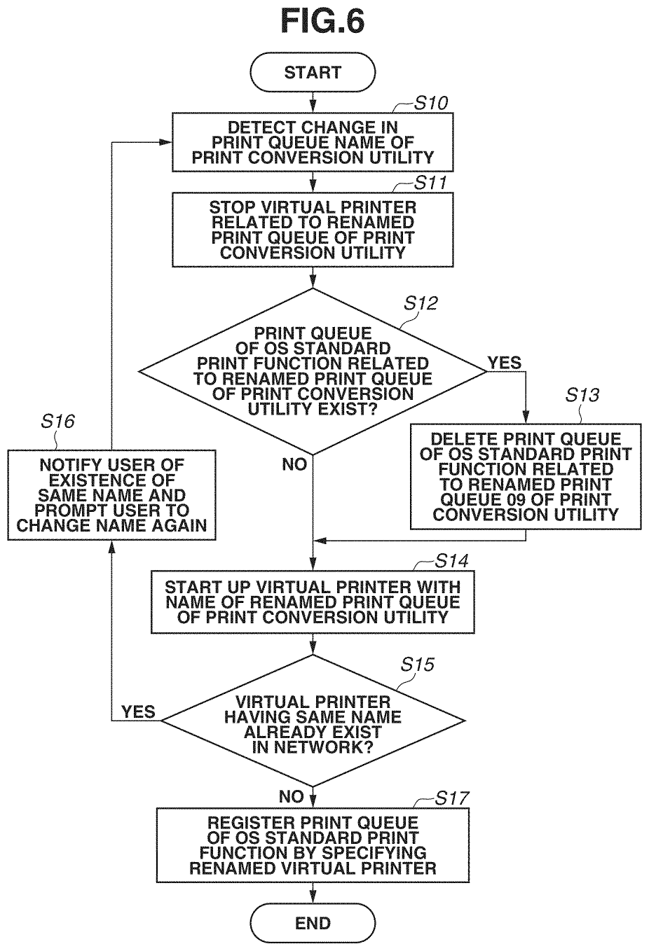

The above-described processing is described in detail below with reference to FIG. 6. FIG. 6 is a flowchart illustrating a processing flow executed by the print conversion utility 07. The processing flow in FIG. 6 is started if a user starts up the print conversion utility 07. FIG. 6 illustrates a case in which the user starts up the print conversion utility 07 and changes the name of the print queue 09 registered in the print conversion utility 07. The print conversion utility 07 is described below as the entity of each process, but in reality, the CPU 201 executes a corresponding program and thus realizes a corresponding function. All pieces of processing are not necessarily executed sequentially on one process, and there may be a case in which the processing is transferred to the OS side once and is called again from the OS. The processing flow in FIG. 6 illustrates main processing by the print conversion utility 07 in an easy-to-understand manner for convenience.

The processing in steps S10 to S14 is similar to that in steps S01 to S05 in FIG. 5 according to the first exemplary embodiment, and thus the description thereof is omitted.

In step S15, the print conversion utility 07 determines whether the name of the virtual printer 10 which is started up already exists in the network. In other words, the print conversion utility 07 determines whether a device (here, a printer) having the same name as the newly registered name of the virtual printer 10 exists in the network. For example, it is assumed that the name of the print queue 09 of the printer 30 registered in the print conversion utility 07 is changed from “printer 30 (print conversion utility)” to “printer 50” in step S10. In this case, the new name of the virtual printer 10 is changed to “printer 50”. However, the name “printer 50” is already imparted to the printer 50 which exists in the network 20 to which the PC 01 belongs. Therefore, in this case, it is determined as YES in step S15, and the processing proceeds to step S16. Whether the device having the same name exists in the network may be determined based on a device name (for example, a Bonjour name) included in information transmitted from each device.

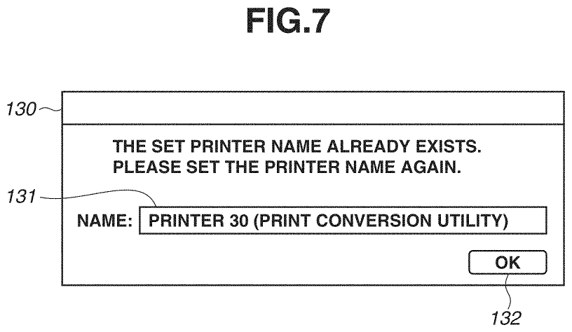

In step S16, the print conversion utility 07 displays a printer name resetting screen 130 in FIG. 7. The printer name resetting screen 130 includes a message notifying a user of a fact that the printer having the changed name already exists. The printer name resetting screen 130 further includes a printer name editing text field 131 for displaying the name of the print queue 09 of the print conversion utility 07 after the name change which is currently set. The printer name editing text field 131 is an input item that the user can edit an input printer name. If the user presses an “OK” button 132 on the printer name resetting screen 130, the print conversion utility 07 changes the name of the print queue 09 of the print conversion utility 07 with a content input to the printer name editing text field 131.

The above-described processing is repeated until the name of the virtual printer 10 does not overlap with a name of another printer in the network 20. For example, it is assumed that the name of the print queue 09 of the printer 30 registered in the print conversion utility 07 is changed from “printer 30 (print conversion utility)” to “favorite printer 30 (print conversion utility)” in step S10. In this case, the new name of the virtual printer 10 is changed to “favorite printer 30 (print conversion utility)”, and this name is different from a name of any printer existing in the network 20 to which the PC 01 belongs. Therefore, in this case, it is determined as NO in step S15, and the processing proceeds to step S17.

In step S17, the print conversion utility 07 executes processing for newly registering the print queue 05 of the OS standard print function by specifying the renamed virtual printer 10 which is started up in step S14. For example, the print conversion utility 07 newly registers the print queue 05 having the name “favorite printer 30 (print conversion utility)” in the OS print system 03 as the print queue 05 related to the virtual printer 10 having the name “favorite printer 30 (print conversion utility)”.

According to the present exemplary embodiment, the above-described processing is performed, and thus the print conversion utility 07 can notify a user of a fact that the name of the virtual printer 10 to be similarly changed based on the name change of the print queue 09 of the print conversion utility 07 already exists in the network. With the notification, the print conversion utility 07 can cause the user to change the name of the print queue 09 of the print conversion utility 07 again. According to the present exemplary embodiment, it is possible to prevent the name of the virtual printer 10 from being changed to the one different from a user's intention, such as a number is added to the end of the name of the virtual printer 10 according to the discovery protocol. Therefore, the present exemplary embodiment has an effect of enabling a user to easily determine the printer for performing printing and to issue an appropriate print instruction. In the above-described example, the processing in step S15 is performed after the processing in step S14. However, the present exemplary embodiment is not limited to this order. It may be determined whether a device having the same name exists in the network before starting up the virtual printer 10. Then, if it is determined that the device having the same name exists in the network, a user notification may be issued in step S16.

Next, a third exemplary embodiment according to the present disclosure is described. In the following description, a part common to the first and third exemplary embodiments is omitted, and only a different point is described. According to the first and the second exemplary embodiments, the virtual printer 10 and the print queue 05 of the OS standard print function are re-registered based on the name change of the print queue 09 of the print conversion utility 07. However, the name of the print queue 05 of the OS standard print function can be manually changed based on a user instruction as described above with reference to FIG. 3. Therefore, if a user changes the name of the print queue 05 of the OS standard print function, the name of the print queue 09 of the print conversion utility 07 and the name of the virtual printer 10 may be different from the name of the print queue 05. Thus, according to the third exemplary embodiment, in a case where a user changes the name of the print queue 05 of the OS standard print function, the name of the print queue 09 of the print conversion utility 07 and the name of the virtual printer 10 are caused to match with the name of the print queue 05 of the OS standard print function.

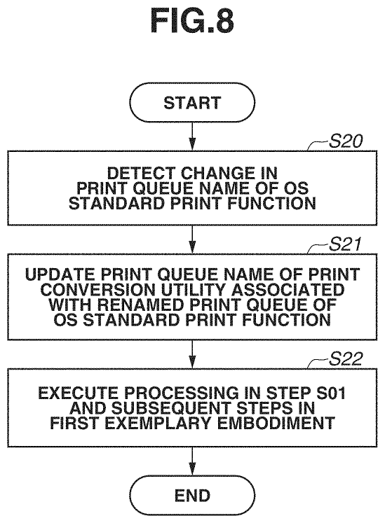

The above-described processing is described in detail below with reference to FIG. 8. FIG. 8 is a flowchart illustrating a processing flow for starting up the print conversion utility. The processing flow in FIG. 8 is started if a user starts up the print conversion utility 07. FIG. 8 illustrates a case in which the user changes the name of the print queue 05 registered in the OS print system 03 using the screen (in FIG. 3) provided by the OS print system 03 in a state in which the print conversion utility 07 is started up. The print conversion utility 07 is described below as the entity of each process, but in reality, the CPU 201 executes a corresponding program and thus realizes a corresponding function. All pieces of processing are not necessarily executed sequentially on one process, and there may be a case in which the processing is transferred to the OS side once and is called again from the OS. The processing flow in FIG. 8 illustrates main processing by the print conversion utility 07 in an easy-to-understand manner for convenience.

In step S20, the print conversion utility 07 detects that the name (identification information) of the print queue 05 of the OS standard print function is changed. In a case where the name of the print queue 05 of the OS standard print function is changed in a period in which the print conversion utility 07 is not started up, the detection is performed by the processing in step S20 at the time of start-up of the print conversion utility 07.

In step S21, the print conversion utility 07 updates the name of the print queue 09 of the print conversion utility 07 associated with the renamed print queue 05 of the OS standard print function with the same name as the renamed print queue 05 of the OS standard print function. For example, it is assumed that the name of the print queue 05 of the OS standard print function is changed from “printer 30 (print conversion utility)” to “favorite printer 30 (print conversion utility)”. In this case, in step S21, the print conversion utility 07 changes the name of the print queue of the printer 30 registered in the print conversion utility 07 from “printer 30 (print conversion utility)” to “favorite printer 30 (print conversion utility)”.

In step S22, the print conversion utility 07 executes the processing in steps S01 to S06 in FIG. 5 described in the first exemplary embodiment. Accordingly, the renamed virtual printer 10 can be registered. In step S22, the print conversion utility 07 may execute the processing in steps S10 to S17 in FIG. 6 described in the second exemplary embodiment.

As described above, according to the present exemplary embodiment, in a case where a user changes the name of the print queue 05 of the OS standard print function, registration of the renamed virtual printer 10 related to the print queue 05 of the OS standard print function and the name change of the print queue 09 of the print conversion utility 07 are executed. Accordingly, the names of the print queue 05 of the OS standard print function, the print queue 09 of the print conversion utility 07, and the virtual printer 10 match with one another. Therefore, the present exemplary embodiment has an effect of enabling a user to easily determine the printer for performing printing and to issue an appropriate print instruction.

### <Other Embodiments>

According to each of the above-described exemplary embodiments, in a case where a print job exists in the print queue 09 in the print conversion utility 07, the print conversion utility 07 may perform control not to receive the name change of the print queue 09. Alternatively, in a case where the name change of the print queue 09 is received in a state in which a print job exists in the print queue 09 in the print conversion utility 07, the print conversion utility 07 may perform control to change the name of the print queue 09 after completing the print job (after the print job is output from the print queue 09).

Embodiments of the present disclosure can also be realized by executing the following processing. More specifically, software (a program) for realizing the functions of the above described exemplary embodiments is supplied to a system or an apparatus via a network or various storage media, and a computer (or a CPU or a micro processing unit (MPU)) of the system or the apparatus reads and executes the program.

According to embodiments of the present disclosure, a technique for enabling an appropriate print instruction using an OS standard print function is provided.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-015179, filed Jan. 31, 2020, which is hereby incorporated by reference herein in its entirety.

What is claimed is:

1. A control method implemented in an information processing apparatus by at least one processor that executes print control software, the control method comprising:
changing identification information of a print queue registered for the print control software from first identification information to second identification information; and
registering, in a case where the identification information of the print queue for the print control software is changed to the second identification information, a virtual printer to which the second identification information is set as a virtual printer communicating with operating system (OS) standard print software related to the print queue.

2. The control method according to claim 1, further comprising executing processing for registering a print queue to which the second identification information is set in the OS standard print software.

3. The control method according to claim 1, wherein, in a case where the identification information of the print queue registered for the print control software is changed to the second identification information, a virtual printer to which the first identification information is set is deleted, and then the virtual printer to which the second identification information is set is newly registered.

4. The control method according to claim 1, wherein, in a case where the identification information of the print queue registered for the print control software is changed to the second identification information, processing for deleting a print queue which is registered for the OS standard print software and is set with the first identification information is executed, and then processing for registering a print queue of the virtual printer to which the second identification information is set is executed.

5. The control method according to claim 1, further comprising, in a case where the virtual printer to which the second identification information is set is registered, determining whether a device with identification information that is the same as the second identification information already belongs to a network to which the information processing apparatus belongs.

6. The control method according to claim 5, wherein, in a case where it is determined that the device with the identification information that is the same as the second identification information already belongs to the network, an input item is displayed which can change the identification information of the print queue registered for the print control software.

7. The control method according to claim 1, further comprising detecting that identification information of a print queue registered for the OS standard print software is changed from first identification information to second identification information,
wherein the identification information of the print queue registered for the print control software is changed from the first identification information to the second identification information based on the detecting.

8. An information processing apparatus comprising:
one or more processors; and
at least one memory storing executable program instructions, which when executed by the one or more processors, cause the information processing apparatus to:
change identification information of a print queue registered for print control software from first identification information to second identification information; and
register, in a case where the identification information of the print queue for the print control software is changed to the second identification information, a virtual printer to which the second identification information is set as a virtual printer communicating with OS standard print software related to the print queue.

9. The information processing apparatus according to claim 8, wherein the executable program instructions, when executed by the one or more processors, further cause the information processing apparatus to execute processing for registering a print queue to which the second identification information is set in the OS standard print software.

10. The information processing apparatus according to claim 8, wherein, in a case where the identification information of the print queue registered for the print control software is changed to the second identification information, a virtual printer to which the first identification information is set is deleted, and then the virtual printer to which the second identification information is set is newly registered.

11. The information processing apparatus according to claim 8, wherein, in a case where the identification information of the print queue registered for the print control software is changed to the second identification information, processing for deleting a print queue which is registered for the OS standard print software and is set with the first identification information is executed, and then processing for registering a print queue of the virtual printer to which the second identification information is set is executed.

12. The information processing apparatus according to claim 8, wherein the executable program instructions, when executed by the one or more processors, further cause the information processing apparatus to, in a case where the virtual printer to which the second identification information is set is registered, determine whether a device with identification information that is the same as the second identification information already belongs to a network to which the information processing apparatus belongs.

13. The information processing apparatus according to claim 12, wherein, in a case where it is determined that the device with the identification information that is the same as the second identification information already belongs to the network, an input item is displayed which can change the identification information of the print queue registered for the print control software.

14. The information processing apparatus according to claim 8, wherein the executable program instructions, when executed by the one or more processors, further cause the information processing apparatus to detect that identification information of a print queue registered for the OS standard print software is changed from first identification information to second identification information,
wherein the identification information of the print queue registered for the print control software is changed from the first identification information to the second identification information based on the detection.
